(19) United States
(12) Patent Application Publication
(10) Pub. No.: US 2024/0066973 A1
(43) Pub. Date: Feb. 29, 2024

(54) WHEEL SIDE

(71) Applicant: Kessler & Co. GmbH & Co. KG, Abtsgmund (DE)

(72) Inventor: Günter BITTLINGMAIER, Aalen (DE)

(21) Appl. No.: 18/234,932

(22) Filed: Aug. 17, 2023

(30) Foreign Application Priority Data
Aug. 24, 2022 (DE) 102022121430.3

(51) Int. Cl. B60K 7/00; B60K 17/04; B60K 17/24; H02K 7/116

(52) U.S. Cl. CPC B60K 7/0007; B60K 17/043; B60K 17/24; H02K 7/116

(57) ABSTRACT

A wheel side comprises: a motor for generating a drive power that comprises a rotor and a stator; a wheel hub; an offset gear that comprises a drive gear coaxial to an input axis for receiving the drive power from the motor and a driven gear coaxial to an output axis offset with respect to the input axis for outputting the drive power to the wheel hub; a drive shaft that is connected to the rotor of the motor, on the one hand, and to the drive gear of the offset gear, on the other hand, for a common rotation; a driven shaft that is connected to the driven gear of the offset gear for a common rotation and that connects the offset gear to the wheel hub; and a driven shaft support for supporting the driven shaft and the driven gear. In this respect, provision is made that the driven shaft support comprises a first bearing that is arranged at an inner periphery of the driven shaft or the driven gear with respect to the output axis to support the driven shaft and the driven gear radially inwardly and that is arranged axially completely within the axial extent of a toothing of the driven gear.

The invention relates to a wheel side in which a drive power, which is generated by a motor and output, is transmitted via a drive shaft to an offset gear, is displaced from an input axis to an output axis by means of the offset gear, and is subsequently transmitted via a driven shaft to a wheel hub.

In particular if such wheel sides are to be particularly compact, difficulties for the support of the drive shaft and the driven shaft and gear wheels of the offset gear connected thereto may result in this respect.

In known wheel sides of this kind, it is customary to support the drive shaft as a motor shaft within the motor, in particular to support it at a housing of the motor, wherein a drive gear of the offset gear that is connected to the drive shaft is then likewise supported at the motor via the drive shaft. An example of this is the wheel side described in DE 10 2010 001 750 A1. However, due to such a kind of drive shaft support, the support of the motor is additionally subjected to a load and in an irregular manner. The offset gear is therefore often designed in a comparatively specific manner by which it is to be avoided that additional forces act from the offset gear on the support of the motor.

For example, a wheel side is described in DE 199 32 587 A1 whose offset gear also comprises additional gear wheels besides a drive gear and a driven gear, with the drive gear not only meshing directly with the driven gear but also being drive-effectively coupled to the driven gear via the additional gear wheels such that the incoming drive power reaches the driven gear via a plurality of paths from the drive gear. The gear wheels meshing directly with the drive gear are in this respect arranged such that the radial forces acting on the drive gear due to the toothed engagements cancel one another out and the drive gear may be supported in a floating manner. To achieve this, the offset gear must, however, have a comparatively complex design and a comparatively large number of gear wheels, in particular compared to a simple spur gear set.

The driven shaft support may also stand in the way of a compact design of the wheel side since it usually comprises at least two bearings that generally each take up their own axial installation space at the driven shaft.

It is an object of the invention to provide a wheel side whose offset gear may have a comparatively simple design and is nevertheless reliably supported in this respect without the support opposing a compact design, in particular an axially compact design, of the wheel side.

The object is satisfied by a wheel side having the features of claim 1. Advantageous embodiments of the invention result from the dependent claims, from the present description, and from the Figures.

The wheel side in accordance with the invention comprises: a motor for generating a drive power that comprises a rotor and a stator; a wheel hub; an offset gear that comprises a drive gear coaxial to an input axis for receiving the drive power from the motor and a driven gear coaxial to an output axis offset with respect to the input axis for outputting the drive power to the wheel hub; a drive shaft that is connected to the rotor of the motor, on the one hand, and to the drive gear of the offset gear, on the other hand, for a common rotation; a driven shaft that is connected to the driven gear of the offset gear for a common rotation and that connects the offset gear to the wheel hub; and a driven shaft support for supporting the driven shaft and the driven gear. In this respect, provision is made in accordance with the invention that the driven shaft support comprises a first bearing that is arranged at an inner periphery of the driven shaft or the driven gear with respect to the output axis to support the driven shaft and the driven gear radially inwardly and that is arranged axially completely within the axial extent of a toothing of the driven gear.

The motor may in particular be an electric motor. As is typical, the stator is stationary in this respect, whereas the rotor rotates during operation of the motor. In this respect, the rotor is preferably coaxial to the input axis so that the rotor and the drive gear of the offset gear may be directly connected to one another via the drive shaft.

The offset gear is preferably configured as a simple spur gear set and thus does not have any further gear wheels in addition to the drive gear and the driven gear. Rather, the drive power received from the motor is transmitted from the drive gear preferably exclusively directly, in particular by a direct toothed engagement of the drive gear with the driven gear, to the driven gear.

Due to the transmission of the drive power from the drive gear to the driven gear, an offset takes place from the input axis, along which the drive power enters the offset gear, to the output axis along which the drive power is output by the offset gear. In this respect, the input axis and the output axis are preferably in parallel with one another. In general, an angled alignment may, however, also be considered.

The drive power output by the driven gear does not necessarily have to be output directly to the wheel hub. In other words, the driven shaft does not have to directly connect the offset gear and the wheel hub to one another, but one or more further functional assemblies may rather be provided between the offset gear and the wheel hub. The wheel side may in particular comprise a wheel hub gear via which the drive power output by the offset gear reaches the wheel hub. The wheel hub gear, which is preferably a reduction gear unit, may in particular be a planetary gear set.

Since the drive shaft is connected to the rotor of the motor, on the one hand, and to the drive gear of the offset gear, on the other hand, for a common rotation, it is configured to transmit the drive power generated by the motor from the motor to the offset gear. In particular, the drive shaft may in this respect be directly connected to both the motor and the drive gear in each case.

The fact that one element is connected to another element for a common rotation in this respect means that the two elements are connected to one another, in particular directly, such that on the rotation of the one element, the respective other element likewise rotates at the same rotational speed, wherein, as a special case of such a connection, the two elements may be formed in one part with one another. This applies not only to the drive shaft and the rotor or the drive gear, but also to other components of the wheel side that are connected to one another for a common rotation, in particular also to the driven shaft that is connected to the driven gear of the offset gear for a common rotation.

The driven shaft is preferably directly connected to the driven gear. However, the driven shaft does not necessarily also have to be directly connected to the wheel hub in order to connect the offset gear to the wheel hub, but the contribution of the driven shaft to the connection of the offset gear to the wheel hub may be limited to the drive power being output by the offset gear via the driven shaft and being transmitted from the driven shaft in the direction of the wheel hub so that the power flow from the offset gear to the wheel hub in any case also takes place via the driven shaft, wherein further components of the wheel side (for example said wheel hub gear) may, however, be provided between the driven shaft and the wheel hub, via which further components the drive power is transmitted from the driven shaft to the wheel side.

To support the driven shaft and the driven gear, said driven shaft support is provided that comprises all those bearings which support the driven shaft and/or the driven gear, in particular directly, at a respective other component of the wheel side. In a corresponding manner, the drive shaft support explained further below comprises all those bearings which support the drive shaft and/or the drive gear, in particular directly, at a respective other component of the wheel side. In this respect, the support may in each case in particular take place at a stationary structure of the wheel side, for instance a housing of the wheel side or an axle housing of a vehicle axle comprising the wheel side.

In this respect, advantages with regard to the installation space required for the wheel side with a simultaneous reliable support of the offset gear in particular result from the particular arrangement of said first bearing of the driven shaft support. The designation of this bearing as the “first bearing” in this respect merely serves to distinguish it conceptually from further bearings and in particular does not imply that the driven shaft support comprises one or more further bearings in addition to the first bearing. The same accordingly also applies to the further bearings with similar designations mentioned further below.

In accordance with the invention, the first bearing of the driven shaft support is arranged at an inner periphery of the driven shaft or the driven gear so that it supports the driven shaft and the driven gear radially inwardly with respect to the output axis. This inner periphery may in particular be designed as a radially inwardly facing lateral surface that extends around the output axis. Such an inner periphery may, for example, be present in that the driven shaft or the driven gear has a hollow shaft section. The first bearing may then be arranged radially within this hollow shaft section with respect to the output axis.

The arrangement of the first bearing at an inner periphery of the driven shaft or the driven gear enables a nested support of the driven gear that may in particular be designed as comparatively compact in an axial direction with respect to the output axis. A further contribution to an axially compact design is that, in accordance with the invention, the first bearing is arranged axially completely within the axial extent of the toothing of the driven gear. In other words, the first bearing is located along the output axis within a region whose axial limits are defined by the axial extent of the toothing of the driven gear along the output axis. In this regard, the first bearing is arranged axially and radially within the driven gear. In addition to the advantages with regard to the installation space, the advantage thereby also results that the first bearing essentially does not have to absorb any tilting moments from the transmission of the drive power from the drive gear to the driven gear.

Since the offset gear is preferably configured as a simple spur gear set, said toothing of the driven gear preferably meshes directly with a toothing of the drive gear of the offset gear. The first bearing is in this respect located radially within the toothing with respect to the output axis and lies axially in one plane with the toothing of the drive gear and the toothing of the driven gear. In other words, in such an embodiment, there is a plane perpendicular to the output axis that intersects both the first bearing and the two toothings of the drive gear and the driven gear.

In accordance with an advantageous embodiment, the driven shaft support comprises a second bearing that is arranged at an outer periphery of the driven shaft or the driven gear with respect to the output axis to support the driven shaft and the driven gear radially outwardly and that is arranged axially offset from the first bearing along the output axis, whereby it has a different position along the output axis than the first bearing. Said outer periphery may in particular be configured as a radially outwardly facing lateral surface with respect to the output axis that extends around the output axis. Together, the first bearing and the second bearing of the driven shaft support may support the driven shaft and the driven gear in a particularly reliable manner.

The second bearing is preferably arranged axially at the side of the driven gear facing away from the motor with respect to the output axis so that the driven gear is arranged between the second bearing and the motor with respect to its position along the output axis. As a result, the motor is neither prevented by the first bearing nor by the second bearing from being arranged axially particularly close to the drive gear and the driven gear of the offset gear for a compact design of the wheel side.

In accordance with an advantageous further development of the above embodiment, said outer periphery, at which the second bearing is arranged, is arranged radially further inwardly with respect to the output axis, i.e. closer to the output axis, than said inner periphery at which the first bearing is arranged. In other words, the outer periphery (i.e. the bearing mount for the second bearing) has a smaller diameter than the inner periphery (i.e. the bearing mount for the first bearing). In combination with the first bearing, a particularly reliable support in particular of the driven gear is thereby achieved. In this respect, the second bearing is preferably arranged directly at the driven gear or axially directly adjacent to the driven gear with respect to the output axis. In this regard, the second bearing may be integrated into the offset gear, which in particular allows the first bearing and the second bearing of the driven shaft support to be lubricated together with the toothed engagement between the toothings of the drive gear and the driven gear, in particular within a common lubrication chamber and with the same lubricant.

In accordance with a further advantageous embodiment, the wheel side further comprises a drive shaft support for supporting the drive shaft and the drive gear, said drive shaft support comprising a third bearing that is arranged axially completely within the axial extent of the rotor of the motor with respect to the input axis. In other words, the third bearing is located along the input axis within a region whose axial limits are defined by the axial extent of the rotor of the motor along the input axis. Thus, even though the drive shaft support extends at least with the third bearing into said region within the rotor of the motor, the third bearing does not necessarily have to be supported against a structure, for instance a housing, of the motor. Rather, it is preferred if, together with the third bearing, a structure of the wheel side that is separate from the motor, in particular a stationary structure, for example a housing of the wheel side or an axle housing of a vehicle axle comprising the wheel side, extends with a support section up to and into said region so that the third bearing may be supported at this support section. In this regard, the drive shaft support may generally be independent of the motor. Rather, it may advantageously even conversely be provided that the rotor of the motor may be supported (indirectly via the drive shaft), in particular exclusively, by the drive shaft support.

Correspondingly, as explained further above, the designation of the bearing as the “third bearing” merely serves for conceptual differentiation (for example, from said first bearing and said second bearing) and in particular does not imply that the drive shaft support comprises one or more further bearings in addition to the third bearing.

Due to said arrangement of the third bearing within the axial extent of the rotor of the motor, the third bearing also does not oppose an axially particularly close arrangement of the motor at the drive gear with respect to the input axis. In this way, the drive shaft and the drive gear may therefore also be reliably supported and the wheel side may nevertheless be configured as axially particularly compact. Furthermore, it is thereby not necessary to provide a complex and elaborate gear shape for the offset gear to avoid an excessive load on the motor connected to the drive gear.

In accordance with a further advantageous further development of the above embodiment, the outer diameter of the third bearing is larger than the outer diameter of the drive gear. It is thereby made possible or at least made easier to install the drive shaft with the drive gear and the third bearing axially from that side of the wheel side at which the motor is provided, in the direction of the wheel hub, into the offset gear.

In accordance with a further advantageous further development of the above embodiment, the drive shaft support comprises a fourth bearing, wherein the third bearing and the fourth bearing are arranged at axially opposite sides of the drive gear with respect to the input axis. In other words, the fourth bearing is located at the side of the drive gear facing away from the motor. Consequently, the drive gear is located along the input axis between the third bearing and the fourth bearing. In this respect, the third bearing and the fourth bearing may in particular be provided directly at the drive shaft and may support it with respect to structures, in particular stationary structures, of the wheel side.

In accordance with an advantageous further development of the above embodiment, the outer diameter of the fourth bearing is smaller than the outer diameter of the drive gear. It is thereby made possible or at least made easier—in particular in connection with the fact that (as described further above) the outer diameter of the third bearing is larger than the outer diameter of the drive gear—to install the drive shaft with the drive gear, the third bearing and the fourth bearing axially from that side of the wheel side at which the motor is provided, in the direction of the wheel hub, into the offset gear.

In particular due to the configuration described in each case, a fixed support/floating support, for which cylindrical bearings and/or grooved ball bearings may be used, may be considered for the drive shaft support and/or for the driven shaft support in each case. Said cylindrical bearings and/or grooved ball bearings offer better efficiency compared to the tapered roller bearings otherwise commonly used so that a further advantage results for the wheel side.

The invention also relates to a portal axle for a motor vehicle, comprising two wheel sides of the explained kind that are connected to one another via an axle bridge. Such portal axles are in particular used in low-floor buses, for example in local transport and city buses, where as large as possible a free space (with respect to the vertical depth and also the horizontal width) is desired for the passengers.

In the following, the invention will be explained further only by way of example with reference to the drawings.

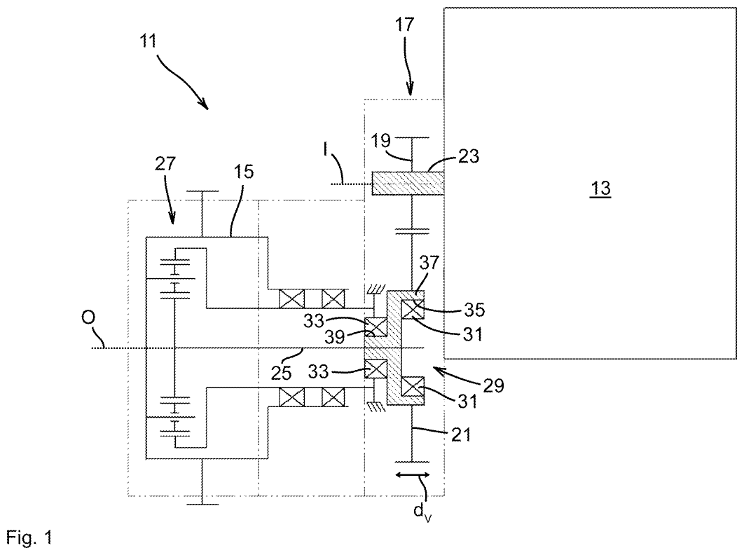

FIG. 1 shows a first embodiment of a wheel side in accordance with the invention in a schematic representation; and

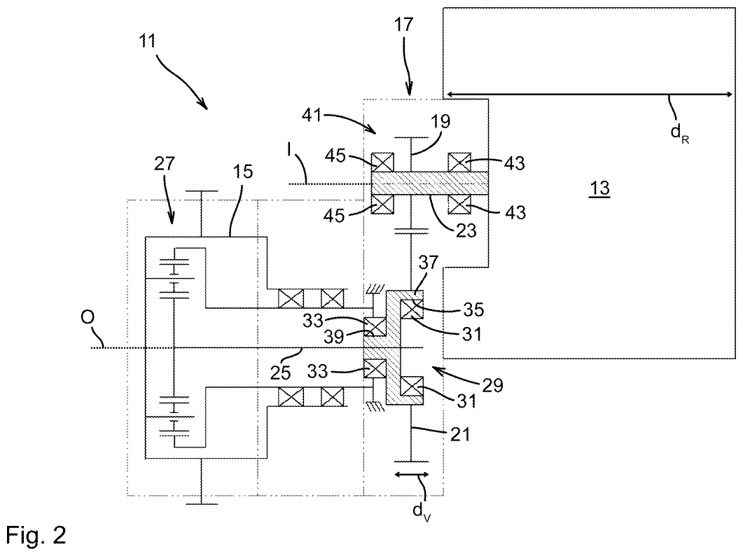

FIG. 2 shows a second embodiment of a wheel side in accordance with the invention in a schematic representation.

The wheel side 11 shown in FIG. 1 is configured in accordance with a first embodiment of the invention and comprises a motor 13 for generating a drive power and a wheel hub 15 that is ultimately driven by the drive power generated by the motor 13. In this respect, the drive power from the motor 13 is output as a rotation about an input axis I, whereas the wheel hub 15 may be rotated about an output axis O.

To offset the drive power from the input axis I to the output axis O, the wheel side 11 comprises an offset gear 17 that in turn comprises a drive gear 19 coaxial to the input axis I and a driven gear 21 coaxial to the output axis O that mesh with one another so that their toothings are directly in a toothed engagement with one another. The drive power is in this respect transmitted from the drive gear 19 to the driven gear 21 solely via this toothed engagement. The offset gear 17 is configured as a simple spur gear set in this regard.

Furthermore, the wheel side 11 comprises a drive shaft 23 and a driven shaft 36. The drive shaft 23 is connected to a rotor, not shown, of the motor 13, on the one hand, and to the drive gear 19, on the other hand, for a common rotation. The drive shaft 23 thereby transmits the drive power generated by the motor 13 along the input axis I, along which the drive shaft 23 extends, to the offset gear 17, namely to the drive gear 19. From the drive gear 19, the drive power is transmitted to the driven gear 21 and is thus offset from the output axis O. The driven shaft 25, which extends along the output axis O, is connected to the driven gear 21 for a common rotation so that the drive power is output by the offset gear 17 via the driven shaft 25 further in the direction of the wheel hub 15.

Another wheel hub gear 27, which is configured as a reducing planetary gear set, is provided between the offset gear 17 and the wheel hub 15. The drive power is therefore transmitted from the driven shaft 25 to the wheel hub gear 27 that ultimately transmits it to the wheel hub 15.

The wheel side 11 furthermore comprises a driven shaft support 29 that serves to support both the driven gear 21 and the driven shaft 25 and that comprises a first bearing 31 and a second bearing 33 for this purpose. The driven gear 21 and the driven shaft 25 may each be directly supported via the bearings 31, 33 of the driven shaft support 29. However, provision may also be made that the driven gear 21 is supported indirectly via the driven shaft 25 or that the driven shaft 25 is supported indirectly via the driven gear 21 by the bearings 31, 33 of the driven shaft support 29. Furthermore, the driven gear 21 and the driven shaft 25 may also be formed in one part.

With respect to the output axis O, the first bearing 31 of the driven shaft support 29 is arranged at an inner periphery 35 of the driven gear 21 or the driven shaft 25, i.e. at a surface that extends in the peripheral direction around the output axis O and is in this respect oriented facing radially inwardly. The first bearing thereby supports the driven gear 21 and the driven shaft 25 radially inwardly. Said inner periphery 35 is formed by a hollow shaft section 37 of the driven gear 21 or the driven shaft 25 within which the first bearing 31 is arranged. The first bearing 31 is in this respect arranged axially completely within the axial extent dᵥ of the toothing of the driven gear 21 with respect to the output axis O. The offset gear 17 may thereby have a comparatively small axial extent.

The second bearing 33 of the driven shaft support 29 is arranged at an outer periphery 39 of the driven gear 21 or the driven shaft 25 with respect to the output axis O and supports the driven gear 21 and the driven shaft 25 radially outwardly. The second bearing 33 is in this respect arranged axially directly adjacent to the driven gear 21 at the side of the driven gear 21 facing away from the motor 13. Furthermore, the bearing mount, formed by the outer periphery 39, for the second bearing 33 has a smaller diameter than the bearing mount, formed by the inner periphery 35, for the first bearing 31.

The second embodiment shown in FIG. 2 differs from the first embodiment shown in FIG. 1 by the manner in which the drive gear 19 and the drive shaft 23 are supported. Since the first embodiment and the second embodiment are otherwise at least substantially agree, the same reference numerals are used in FIG. 2 as in FIG. 1 and the elements of the respective wheel side 11 already explained with reference to FIG. 1 are not described again.

In the second embodiment shown in FIG. 2, the wheel side 11 comprises a drive shaft support 41 that comprises two bearings for supporting the drive gear 19 and the drive shaft 23 that are referred to as the third bearing 43 and the fourth bearing 45 to distinguish them from the bearings of the driven shaft support 29. The drive gear 19 and the drive shaft 23 may each be directly supported via the bearings 43, 45 of the drive shaft support 41. However, provision may also be made that the drive gear 19 is supported indirectly via the drive shaft 23 or that the drive shaft 23 is supported indirectly via the drive gear 19 by the bearings 43, 45 of the drive shaft support 41. Furthermore, the drive gear 19 and the drive shaft 23 may also be formed in one part.

The third bearing 43 and the fourth bearing 45 are arranged at axially opposite sides of the drive gear 19, wherein the third bearing 43 is arranged axially completely within the axial extent d R of the rotor, not shown in the Figures, of the motor 13 with respect to the input axis I. As a result, a particularly reliable drive shaft support 41 may be achieved without the motor-side third bearing 43 taking up additional axial installation space and thereby impeding an axially closely adjacent arrangement of the motor 13 at the drive gear 19 of the offset gear 17 with respect to the input axis I.

### REFERENCE NUMERALS

11 wheel side
13 motor
15 wheel hub
17 offset gear
19 drive gear
21 driven gear
23 drive shaft
25 driven shaft
27 wheel hub gear
29 driven shaft support
31 first bearing
33 second bearing
35 inner periphery
37 hollow shaft section
39 outer periphery
41 drive shaft support
43 third bearing
45 fourth bearing
d_{R} axial extent of the rotor
d_{V} axial extent of the toothing
I input axis
O output axis

1. A wheel side comprising:
a motor that comprises a rotor and a stator and that generates a drive power;
a wheel hub;
an offset gear that comprises a drive gear, which is coaxial to an input axis and which receives the drive power from the motor, and a driven gear that is coaxial to an output axis offset with respect to the input axis and that outputs the drive power to the wheel hub;
a drive shaft that is connected to the rotor of the motor, on the one hand, and to the drive gear of the offset gear, on the other hand, for a common rotation;
a driven shaft that is connected to the driven gear of the offset gear for a common rotation and that connects the offset gear to the wheel hub; and
a driven shaft support that supports the driven shaft and the driven gear and that comprises a first bearing that is arranged at an inner periphery of the driven shaft or the driven gear with respect to the output axis to support the driven shaft and the driven gear radially inwardly and that is arranged axially completely within the axial extent of a toothing of the driven gear.

2. The wheel side according to claim 1,
wherein the driven shaft support comprises a second bearing that is arranged at an outer periphery of the driven shaft or the driven gear with respect to the output axis to support the driven shaft and the driven gear radially outwardly and that is arranged axially offset from the first bearing along the output axis.

3. The wheel side according to claim 2,
wherein the outer periphery at which the second bearing is arranged is arranged radially further inwardly with respect to the output axis than the inner periphery at which the first bearing is arranged.

4. The wheel side according to claim 1,
further comprising:
a drive shaft support that supports the drive shaft and the drive gear and that comprises a third bearing that is arranged axially completely within the axial extent of the rotor of the motor with respect to the input axis.

5. The wheel side according to claim 4,
wherein the outer diameter of the third bearing is larger than the outer diameter of the drive gear.

6. The wheel side according to claim 4,
wherein the drive shaft support comprises a fourth bearing and the third bearing and the fourth bearing are arranged at axially opposite sides of the drive gear with respect to the input axis.

7. The wheel side according to claim 6,
wherein the outer diameter of the fourth bearing is smaller than the outer diameter of the drive gear.

8. The wheel side according to claim 1 installed in a portal axle together with a further wheel side of the same kind, wherein the wheel side and the further wheel side of the same kind are connected to one another via an axle bridge.

9. A wheel side comprising:
a motor that comprises a rotor and a stator and that generates a drive power;
a wheel hub;
an offset gear that comprises a drive gear, which is coaxial to an input axis and which receives the drive power from the motor, and a driven gear that is coaxial to an output axis offset with respect to the input axis and that outputs the drive power to the wheel hub;
a drive shaft that is connected to the rotor of the motor, on the one hand, and to the drive gear of the offset gear, on the other hand, for a common rotation;
a driven shaft that is connected to the driven gear of the offset gear for a common rotation and that connects the offset gear to the wheel hub; and
a driven shaft support that supports the driven shaft and the driven gear and that comprises a first bearing that is arranged at an inner periphery of the driven shaft or the driven gear with respect to the output axis to support the driven shaft and the driven gear radially inwardly and that is arranged axially completely within the axial extent of a toothing of the driven gear; and
a drive shaft support that supports the drive shaft and the drive gear and that comprises a third bearing, which is arranged axially completely within the axial extent of the rotor of the motor with respect to the input axis, and a fourth bearing, wherein the third bearing and the fourth bearing are arranged at axially opposite sides of the drive gear with respect to the input axis.

10. The wheel side according to claim 9,
wherein the outer diameter of the fourth bearing is smaller than the outer diameter of the drive gear.
